(19) United States
(12) Patent Application Publication
(10) Pub. No.: US 2004/0232194 A1
(43) Pub. Date: Nov. 25, 2004

(54) Enhanced electrical motor driven nail gun

(76) Inventors: Christopher S. Pedicini, Roswell, GA (US); John D Witzigreuter, Kennesaw, GA (US)

Correspondence Address: Jonathan H Petcu, Moore Ingram Johnson & Steele, 192 Anderson Street, Marietta, GA, 30060, US

(21) Appl. No.: 10/479,823

(22) PCT Filed: Dec. 18, 2002
(86) PCT No.: PCT/US02/40666

(30) Foreign Application Priority Data
Mar. 7, 2002 (US) 10/091/410

(51) Int. Cl. B25C 5/06

(52) U.S. Cl. 227/131

(57) ABSTRACT

A portable electric nailing gun operating from a power supply. The motor accelerates a flywheel which at the appropriate energy state is coupled through a mechanism to an anvil acting directly on the nail. The actuation is governed by a control circuit and initiated from a trigger switch. The motor accelerates a flywheel that is then clutched to the output anvil causing the nail to be driven. The position of the output anvil is sensed and once the nail is driven, the motor is dynamically braked reducing the excess energy in the flywheel. This method uses an intermediate link in the drive train and a position sensitive nailing mechanism to reduce wear and increase robustness of the nailer. The electrical control circuit and brake allow precise control and improve safety. The power supply is preferably a rechargeable low impedance battery pack.

### BACKGROUND ART

This invention relates to fastening mechanisms, specifically to such nail or staple fastening mechanisms that require operation as a hand tool. This invention relates generally to an electromechanical fastener driving tool. Such devices are less than 15 pounds and are completely suitable for an entirely portable operation.

Contractors and homeowners commonly use power-assisted means of driving fasteners into wood. These can be either in the form of finishing nail systems used in baseboards or crown molding in house and household projects, or in the form of common nail systems that are used to make walls or hang sheathing onto same. These systems can be portable (not connected or tethered to an air compressor or wall outlet) or non-portable.

The most common fastening system uses a source of compressed air to actuate a cylinder to push a nail into the receiving members. For applications in which portability is not required, this is a very functional system and allows rapid delivery of nails for quick assembly. It does however require that the user purchase an air compressor and associated air-lines in order to use this system.

Thereafter, inventors have created several types of portable nail guns operating off of fuel cells. Typically these guns have a cylinder in which a fuel is introduced along with oxygen from the air. The subsequent mixture is ignited with the resulting expansion of gases pushing the cylinder and thus driving the nail into the work pieces. Typical within this design is the need for a fairly complicated assembly. Both electricity and fuel are required as the spark source derives its energy typically from batteries. In addition, it requires the chambering of an explosive mixture of fuel and the use of consumable fuel cartridges. Systems such as these are already in existence and are sold commercially to contractors under the Paslode name.

There are other nail guns that are available commercially, which operate using electrical energy. They are commonly found as electric staplers and electric brad tackers. The normal mode of operation for these devices is through the use of a solenoid that is driven off of a power cord that is plugged into a wall outlet. One of the drawbacks of these types of mechanisms is that the number of ampere-turns in the solenoid governs the force provided by a solenoid. In order to obtain the high forces required for driving brads and staples into the work piece, a larger number of turns are required in addition to high current pulses. These requirements are counterproductive as the resistance of the coil increases in direct proportion to the length of the wire in the solenoid windings. The increased resistance necessitates an increase in the operational voltage in order to keep the amps thru the windings at a high level and thus the ampere-turns at a sufficiently large level to obtain the high forces needed to drive the nail. This type of design-suffers from a second drawback in that the force in a solenoid varies in relation to the distance of the solenoid core from the center of the windings. This limits most solenoid driven mechanisms to short stroke small load applications such as paper staplers or small brad tackers.

The prior art teaches three additional ways of driving a nail or staple. The first technique is based on a multiple impact design. In this design, a motor or other power source is connected to the impact anvil thru either a lost motion coupling or other. This allows the power source to make multiple impacts on the nail thus driving it into the work piece. There are several disadvantages in this design that include increased operator fatigue since the actuation technique is a series of blows rather than a continuous drive motion. A further disadvantage is that this technique requires the use of an energy absorbing mechanism once the nail is seated. This is needed to prevent the heavy anvil from causing excessive damage to the substrate. Additionally, the multiple impact designs normally require a very heavy mechanism to insure that the driver does not move during the driving operation.

A second design that is taught includes the use of potential energy storage mechanisms in the form of a spring. In these designs, the spring is cocked (or activated) through an electric motor. Once the spring is sufficiently compressed, the energy is released from the spring into the anvil (or nail driving piece) thus pushing the nail into the substrate. Several drawbacks exist to this design. These include the need for a complex system of compressing and controlling the spring and the fact that the force delivery characteristics of a spring are not well suited for driving nails. As the nail is driven into the wood, more force is needed as the stroke increases. This is inherently backwards to a springs unloading scheme in which it delivers less force as it returns to its zero energy state.

A third means for driving a fastener that is taught includes the use of flywheels as energy storage means. The flywheels are used to launch a hammering anvil that impacts the nail. This design is described in detail in patent U.S. Pat. Nos. 4,042,036, 5,511,715 and 5,320,270. The major drawback to this design is the problem of coupling the flywheel to the driving anvil. This prior art teaches the use of a friction clutching mechanism that is both complicated, heavy and subject to wear. This design also suffers from difficulty in controlling the energy left over after the nail is driven. Operator fatigue is also a concern as significant precession forces are present with flywheels that rotate in a continuous manner. An additional method of using a flywheel to store energy to drive a fastener is detailed in British Patent # 2,000,716. This patent teaches the use of a continuously rotating flywheel coupled to a toggle link mechanism to drive a fastener. This design is limited by the large precession forces incurred because of the continuously rotating flywheel and the complicated and unreliable nature of the toggle link mechanism. All of the currently available devices suffer from a number of disadvantages that include:

1. Complexity of design. With the fuel driven mechanisms, portability is achieved but the design is inherently complicated. Mechanisms from the prior art that utilize rotating flywheels have enormously complicated coupling or clutching mechanisms. Devices that use springs as a potential energy storage device also have complicated spring compression mechanisms.

2. Noisy. The ignition of an explosive mixture to drive a nail causes a very loud sound and presents combustion fumes in the vicinity of the device. Multiple impact devices have a loud jack hammer type noise.

3. Complexity of operation. Combustion driven portable nail guns are more complicated to operate. They require consumables (fuel) that need to be replaced.

4. Use of consumables. Combustion driven portable nail gun designs use a fuel cell that dispenses a flammable mixture into the piston combustion area. The degree of control over the nail operation is very crude as you are trying to control the explosion of a combustible mixture.

5. Non-portability. Traditional nail guns are tethered to a fixed compressor and thus must maintain a separate supply line.

6. Using a spring as a potential energy storage device suffers from unoptimized drive characteristics. Additionally, the unused energy from the spring which is not used in driving the nail must be absorbed by the tool causing excessive wear.

7. The flywheel type storage devices suffer from significant precession forces as the flywheels are not intermittent and are left rotating at high speeds. This makes tool positioning difficult. The use of counter-rotating flywheels as a solution to this issue increases the complexity and weight of the tool.

8. Need for precise motor control for repeatable drives. Flywheel designs that throw an anvil must control flywheel speeds ±1% to ensure repeatable drives. This creates a need for highly complex and precise control over the motor.

### DISCLOSURE OF INVENTION

In accordance with the present invention, a fastening mechanism is described which derives its power from a low impedance electrical source, preferably rechargeable batteries, and uses a motor to directly drive a kinetic energy storage mechanism which couples to a fastener driving mechanism and drives a fastener into a substrate. Upon receipt of an actuation signal from an electrical switch, an electronic circuit connects a motor to the electrical power source. The motor is coupled to a kinetic energy storing mechanism, such as a flywheel, preferably through a speed reduction mechanism. Both the motor and the flywheel begin to spin. Within a prescribed number of revolutions, the flywheel is clutched to a fastener driving device that drives the anvil through an output stroke. The preferred fastener driving device is a reciprocating mechanism. The clutching mechanism is preferably of a mechanical lockup design that allows for rapid and positive connection of the fastener driving device to the energy stored in the flywheel. A position indicating feedback device sends a signal to the electronics when the fastener driving device is approximately at the bottom dead center of the stroke. The electronics processes this signal and disconnects the motor from the power source and begins to brake the flywheel. The preferred mode for the braking mechanism is to use dynamic braking from the motor followed by motor reversal if required to stop the flywheel within a prescribed distance. The clutching mechanism is preferably designed to allow significant variance in terms of the starting and stopping points to allow for a robust design. Once the brake is applied and the electronics completely reset, the fastening mechanism is ready for another cycle.

Accordingly, in addition to the objects and advantages of the portable electric nail gun as described above, several objects and advantages of the present invention are:

1. To provide a sensing element that determines when the fastening mechanism is ready for another cycle.

2. To provide control circuitry that utilizes a microprocessor allowing improved robustness during jam conditions.

3. To provide a fastener driving mechanism that reduces the reciprocated inertia during the nail drive thereby allowing the use of small brakes and bumpers.

4. To provide a fastener driving device that is more robust than previous designs by providing better surface guiding on the sliding components.

5. To provide a fastening mechanism that uses a hardened flywheel bar as an insert.

6. To provide a fastening mechanism that uses a barrel cam to actuate a mechanical lockup clutch giving a positive advance and retract of the drive pin.

7. To provide a fastening mechanism that uses a torsion spring to retract the nail driving mechanism to improve reliability and reduce cost.

8. To provide a fastening mechanism which has compliance during the engagement of the kinetic energy storing mechanism to the fastener driving mechanism thus reducing system wear.

9. To provide a counter which keeps track of flywheel revolutions and which coordinates with the crank position sensors to allow for robust tool operation.

The operation of the invention in driving a nail into a substrate has significant improvements over that which has been described in the art. First, nails are loaded into a magazine structure. The nail gun is then placed against the substrates, which are to be fastened, and the trigger is actuated. The trigger allows a fastener-driving device that uses energy stored in a kinetic energy storage mechanism to push the nail, or other fastener, into the substrate. The kinetic energy storage mechanism is a combination of the rotational kinetic energy stored in the entire drive train. This includes the motor, the gear sets and the flywheel bar (described later). Following the nail drive, the nail gun then returns to a rest position and waits for another signal from the user before driving another nail. These operations, from pulling the trigger to returning to a rest state constitute an intermittent cycle. The nail driving height can be set using an adjustable foot at the bottom end of the nail gun. It should be understood by those skilled in the art that alternate mechanisms for coupling the flywheel to the drive anvil can be used.

### BRIEF DESCRIPTION OF DRAWINGS

In the drawings, closely related figures have the same number but different alphabetic suffixes.

FIG. 1 is an overview of the fastener-driving tool embodying the invention;

FIG. 2 is isometric view of the fastener driving mechanism detailing the mechanism;

FIG. 3 is isometric view of the fastener driving mechanism detailing the mechanism;

FIG. 4 is a side elevation of the barrel cam used in the fastener driving mechanism;

FIG. 5 is a front elevation and an isometric view of part of the preferred embodiment of the nail driving mechanism;

FIG. 6 is a side elevation of the motor and motor coupling used in the nail driving mechanism;

FIG. 7 is a side elevation of the motor and flexible shaft coupling used in the nail driving mechanism;

FIG. 8 is a side elevation of the nail driving mechanism and a block diagram of control circuitry and power source of the invention;

FIG. 9 is an electrical schematic of the fastener-driving tool circuit;

Reference numbers in Drawings:

1 Fastener-Driving Tool

2 Nail Driving Mechanism

3 Power Source

4 Motor

5 Motor Mount

6 Flywheel Gear

7 Flywheel Bar

8 Intermediate Link

9 Control Circuit Device

10 Activation Switch

11 Fastener Driver Blade (Anvil)

12 Fastener (Nail)

13 Crank Link

14 Mechanism Guide

15 Flywheel Pinion

16 Cam Gear Pinion

17 Cam Gear

18 Barrel Cam

19 Drive Pin

20 Drive Shaft

21 Mechanism Return Spring

22 Handle

23 Feeder Mechanism

24 Substrate

25 Anvil Guide

26 TDC Sensor

27 BDC Sensor

28 Motor Output Shaft

29 Motor Coupling

30 Top Dead Center Bumper

31 Bottom Dead Center Bumper

32 Logic Circuit

33 On Timer Delay Circuit

34 Power Switching Circuit

35 Flywheel Speed Detection Sensor

36 Off Time Delay Circuit

37 Cooling Fan

38 Fusible Link

### BEST MODE FOR CARRYING OUT INVENTION

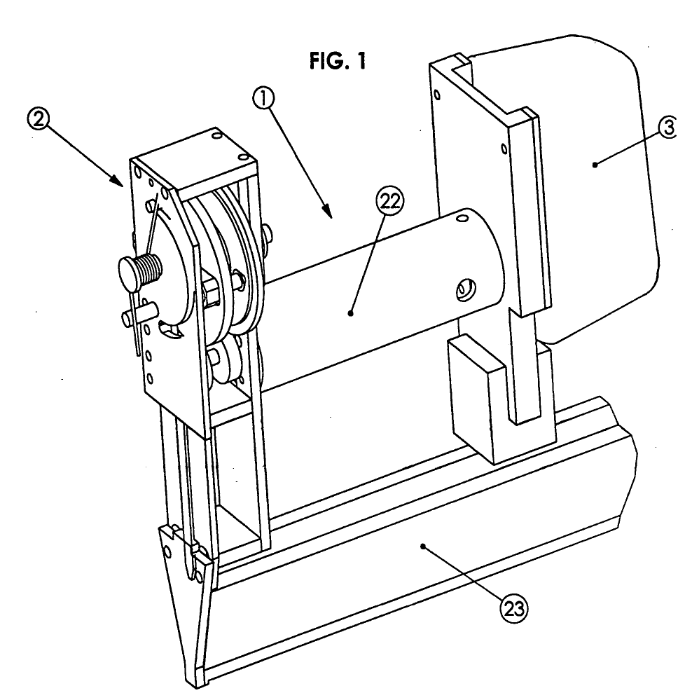

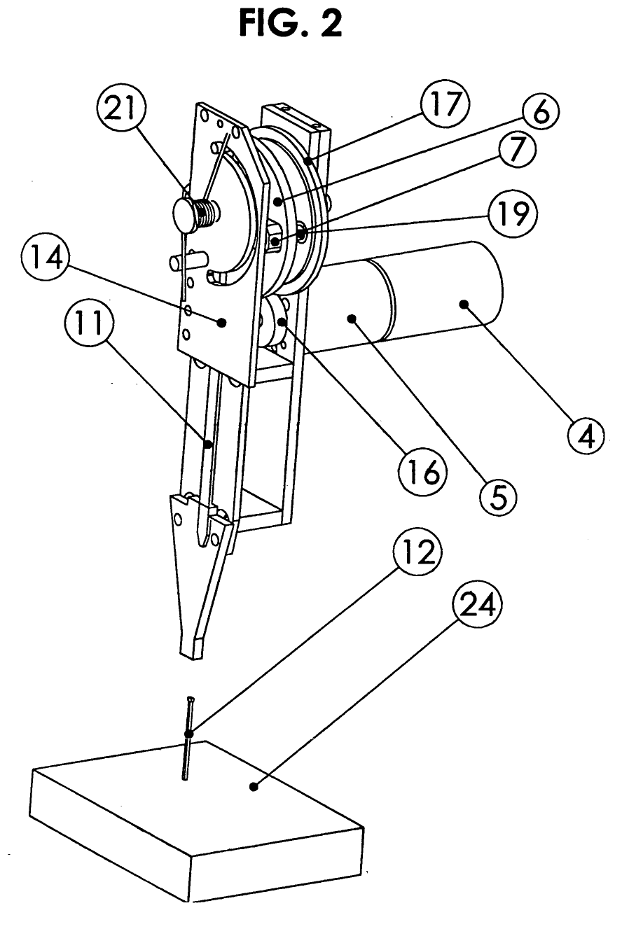

FIGS. 1-8 represent a preferred embodiment of a fastener-driving tool (1) for driving fasteners such as nails (12) into substrates (24) such as wood. Referring to FIG. 1, the preferred embodiment includes a drive unit that can deliver a force or pulse through a stroke such as, for example, a fastener-driving tool (1). The fastener-driving tool (1) comprises a handle (22), a feeder mechanism (23), and the nail driving mechanism (2). The feeder mechanism is spring biased to force fasteners, such as nails or staples, serially one after the other, into position underneath the nail-driving anvil. FIGS. 2-5 detail the nail driving mechanism. Referring to FIG. 2, the motor (4) is controlled over an intermittent cycle to drive a nail (12) beginning by placing the fastener-driving tool (1) against the substrates (24), which are to be fastened, and actuating a switch (10). This intermittent cycle ends when the nail (12) has been driven and the nail driving mechanism (2) is reset and ready to be actuated again. This intermittent cycle can take up to 2 seconds but preferably takes less than 500 milliseconds.

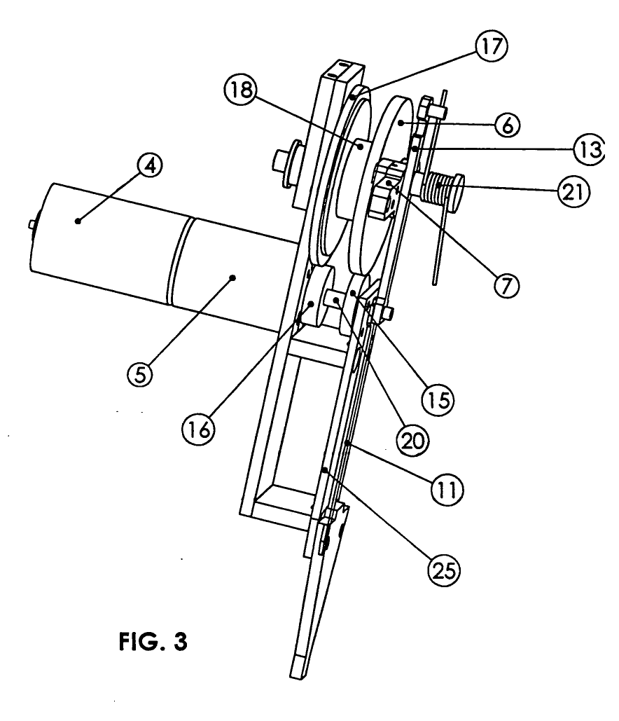

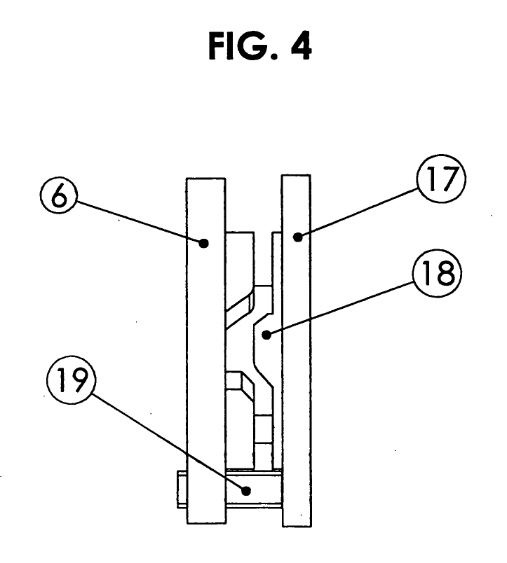

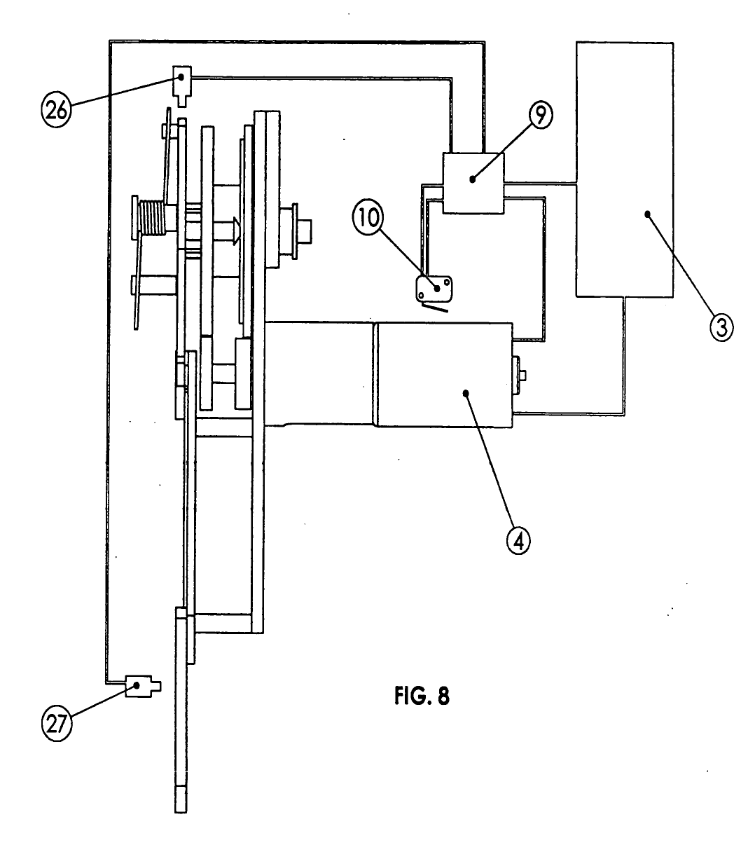

Referring to FIG. 8, the control circuitry (9) and switch (10) apply power to the motor (4) from power source (3). Referring to FIG. 2-3, the motor (4) is coupled to the drive shaft (20). The drive shaft (20) drives both the flywheel gear (6) and the cam gear (17) through the flywheel pinion (15) and the cam gear pinion (16) respectively. The applied power causes the flywheel gear (6) and the cam gear (17) to rotate. The ratio of the cam gear (17) and the cam gear pinion (16) in relation to the ratio of the flywheel pinion (15) and the flywheel gear (6) are not the same. This initiates relative motion between the cam gear (17) and the flywheel gear (6) i.e. the cam gear and the flywheel gear are rotating at different speeds. Referring now to FIG. 4, the barrel cam (18) is connected to the cam gear (17) and rotates with same. As the cam gear (17) and the flywheel gear (6) rotate, the barrel cam (18) moves relative to the drive pin (19). The drive pin (19) is located through a hole in the flywheel bar (7) and rides in the barrel cam (18). The gear ratio differential between the flywheel gear (6) and the cam gear (17) is such that the flywheel gear (6) makes from 1-60 revolutions before the barrel cam (18) engages the drive pin (19). As the barrel cam (18) initiates contact with the drive pin (19), the drive pin (19) protrudes through the face of the flywheel bar (7), seen in FIG. 3. As the flywheel gear (6) and flywheel bar (7) rotate with the drive pin (19) extended, the drive pin (19) engages the crank link (13). The crank link (13), the flywheel bar (7), the drive pin (19) and the fastener driver blade (anvil) (11) then form a slider crank mechanism. The anvil (11) slides up and down the anvil guide (25) and makes contact to drive the nail (12). Once the anvil (11) has substantially hit bottom dead center (i.e. the nail is fully driven into the substrate), the BDC sensor (27) informs the control circuit (9) that the nail (12) has been completely driven into the substrate (24). The motor power is then removed and the motor windings are connected together thru a low resistance connection (preferable less than 100 milli ohms). This allows for a rapid slow down of the motor (4) and the drive train during the next ¼ to 5 revolutions of the flywheel.

The kinetic energy storage mechanism can possess varying amounts of energy depending on the length of the nail and the substrate the nail is being driven into. If the tool were to be dry cycled without engaging a nail the kinetic energy storage mechanism would possess much more energy than if the tool had just driven a 2½ inch nail into an oak substrate. By allowing numerous revolutions to store energy kinetically, the energy stored can be kept relatively constant despite differences caused by the number of braking revolutions.

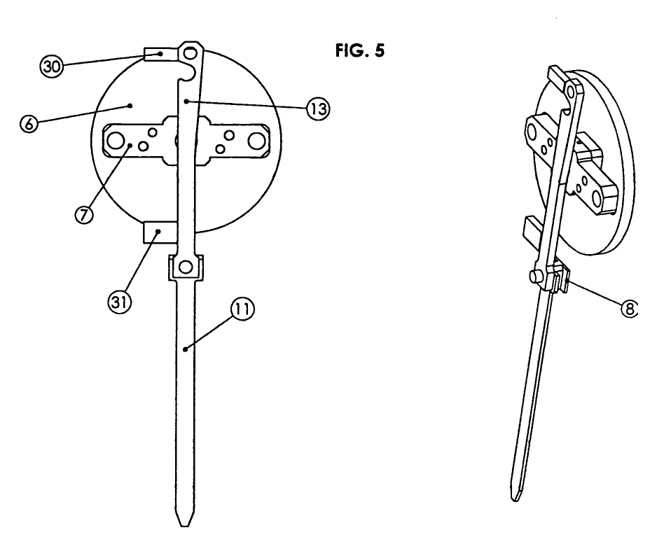

After the anvil reaches bottom dead center, the crank link (13) automatically disengages from the drive pin (19). It should be understood that bottom dead center (BDC) and top dead center (TDC) refer to approximate positions of the fastener driving mechanism. The crank link (13) is designed only to engage the drive pin (19) from about TDC to about BDC and can not be driven by the drive pin past about BDC due to the design of the crank link (13). This makes the crank link (13) position sensitive and it is depicted in FIG. 5. After the crank link (13) disengages from the drive pin (19) the crank link (13) hits the bottom dead center bumper (31). The bottom dead center bumper (31) is designed to absorb the remaining energy in the crank link (13) and is preferably made of an elastic material. This remaining energy is typically less than 18 inch-lbs. Returning to FIG. 4, once the anvil (11) reaches past bottom dead center the barrel cam (18) forces the retraction of the drive pin (19). It should be understood that a single acting barrel cam using a drive pin that has a spring return is also within the scope of this invention. The drive pin (19) is then retracted and no longer protrudes from the face of the flywheel bar (7). The mechanism return spring (21) then biases the crank link (13) and the anvil (11) towards top dead center against the top dead center bumper (30) in readiness for the next cycle. The TDC sensor. (26) then determines if the mechanism-Is ready for the next cycle. The mechanism return biasing means such as a spring (21) can be any elastic element that provides rotational torque to the crank link. The preferred spring in this application is a torsional spring.

In this preferred embodiment, the flywheel (6) is connected to the flywheel bar (7). The flywheel bar (7) serves several purposes. The flywheel bar (7) is a hardened steel bar that has a precision hole drilled in it to act as the guide for the drive pin (19). A long guiding surface is important to prevent the drive pin (19) from binding when it is being moved in and out by the barrel cam (18). The flywheel bar (7) also can allow the use of plastic or aluminum gears in the nail driving mechanism (2) by taking most of the force of engaging the drive pin (19) with the crank link (13) and the force used in driving the fastener (12). Plastic gears offer a significant cost reduction over other types of gears.

Another aspect of this preferred embodiment is the use of an intermediate link (8) connecting the crank link (13) and the anvil (11). This is detailed in FIG. 5. The intermediate link (8) serves two purposes. The first purpose is to capture the anvil (11) at the top end to ensure that it is fixed. Fixing the top end of the anvil (11) makes the anvil (11) more rigid and resistant to buckling. When the anvil (11) starts to drive a fastener it acts as a long column. When both ends of this column are better constrained as in this fashion, the force required to buckle the anvil can be increased by as much as 50% or more. The second purpose of the intermediate link (8) is to create a large area for the anvil drive forces to bear upon as it rides in the anvil guide (25). This large contact is subject to very little wear and creates a robust sliding interface.

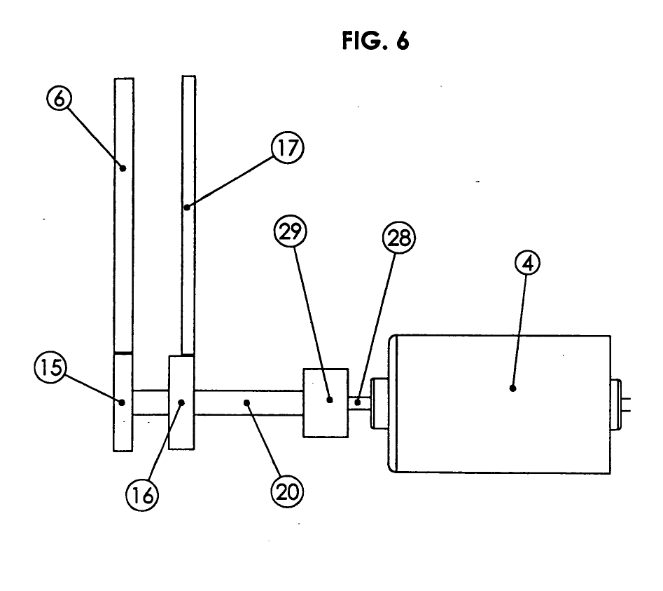

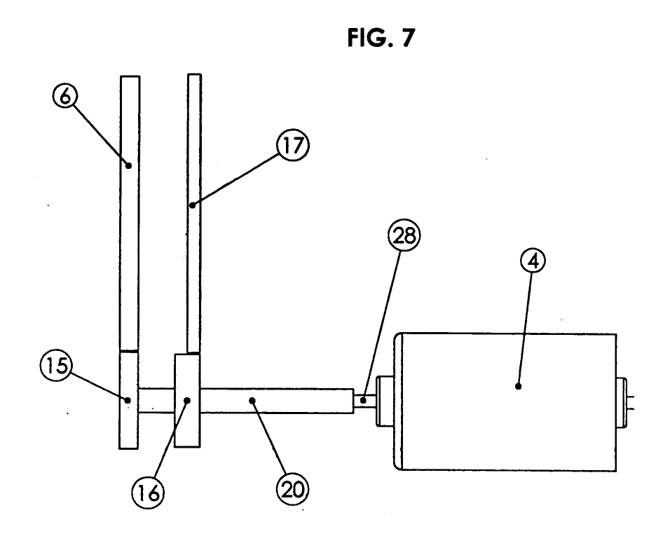

FIG. 6-7 show yet another aspect of the preferred embodiment. When the drive pin (19) engages the crank link (13), all of the energy to accelerate the crank link to speed must be delivered quickly. This energy comes from the entire drive train. This includes the flywheel/flywheel bar combination, the barrel cam/cam gear and the motor. The motor inertia represents a significant portion of the overall energy transfer, on the order of ⅓ in many cases. Since the motor inertia and the cam/cam gear inertia must be transferred through the drive pin to the crank link, it must be transferred through the gear teeth. If this transfer takes place instantaneously or nearly instantaneously i.e. over a small angular displacement , the forces on the gear teeth can exceed the rating for the gears and cause excessive gear wear. To prevent excessive wear the torque transmitted through the gears and the fastener driving mechanism must be below the yield rating for these materials. To achieve this effect the energy must be supplied over a larger time period, or an increased angular displacement. This is accomplished by introducing compliance which we define as linear and angular flexibility within the kinetic energy storage mechanism and the nail driving mechanism. This compliance is of such a nature that the yield points of the various component materials are not exceeded upon impact of the clutch driving pin to the nail driving mechanism. Three methods are described below that accomplish this although others would be familiar to one skilled in the art. The first method is to use a motor coupling (29) between the motor output shaft (28) and the drive shaft (20). Any form of flexible coupling such as a spider coupling will suffice. This flexible motor coupling (29) should allow from 1-15° of angular rotation between the shafts. This would allow the energy in the motor to be transmitted over a larger time period thus reducing the peak torque load on the gears. The second method of reducing the peak torque seen by the gears is to use an engineered drive shaft (20). This engineered drive shaft (20) would allow angular deflection when large torques are applied. The important parameters for designing the proper deflection include shaft diameter, shaft length and the material of the shaft. The final method for reducing the peak torque seen by the gears is to allow compliance in the crank link (13). This compliance can take two forms. The first method is to use an elastomeric material that deforms as the drive pin (19) hits the crank link (13). This form of compliance allows the crank link (13) to accelerate over more time reducing the peak torque seen by the gears. The second and preferred method for adding compliance to the crank link (13) is to design the crank link (13) as a flexible beam. By properly engineering the cross section of the crank link (13), the crank link will bend instantaneously upon impact by the drive pin (19). This beam flexure can be highly significant in terms of reducing the overall torque that the gears must supply;

By utilizing these methods of reducing the instantaneous gear torque either independently or in combination, the need for hardened steel gears is reduced. These methods allow the use of aluminum or plastic as gear materials thereby greatly reducing the cost of these components.

Circuit Description

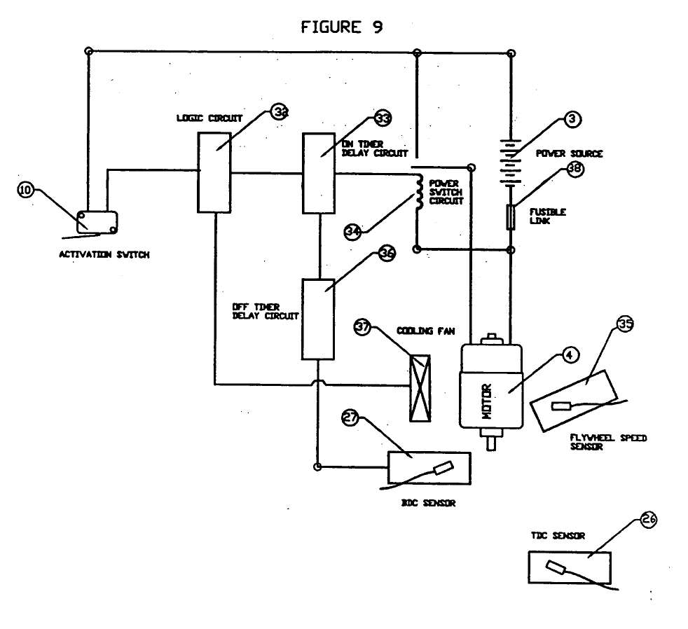

The following is a description of the control circuitry for the fastener driving tool (1). A block diagram is shown in FIG. 9. The actual design details for this circuit are familiar to an electrical engineer and could be implemented by one skilled in the art.

In the circuit, the operator actuates the activation switch (10). The electrical signal from the activation switch is sent into the logic circuit (32). The logic circuit (32) determines that all requirements for the safe actuation of the firing mechanism have been met. If the safety requirements have been met, the on timer delay circuit (33) is activated. The on timer delay circuit (33) supplies a signal to the power switching circuit (34) for a predetermined period of time. This time can range from 50 to 700 milliseconds with the preferred timing range of 200-300 milliseconds. During this period, the power switching circuit (34) connects a low impedance power source (3) to the motor (4) allowing it to rapidly accelerate an energy storage mechanism for later coupling and release to the nail driving mechanism (2). The power switching circuit (34) consists of low impedance switches having an on resistance of less than 25 milliohms. In addition, a flywheel speed detection sensor (35) can be used. This speed detection sensor (35) allows the motor to maintain a constant velocity once sufficient energy for driving the fastener into the substrate has been achieved. By maintaining the motor at an approximate constant rotational velocity, the rotational energy in the kinetic energy storage mechanism can be maintained more consistently from cycle to cycle. This results in a more consistent drive for the nail and also increases the nail drives per charge.

Once the nail driving mechanism (2) has been coupled to the flywheel bar (7), the BDC sensor (27) is used to detect the position of the anvil. This allows accurate timing for disconnecting the power source (3) from the motor (4). The BDC sensor (27) can be used in conjunction with a timing circuit to allow said sensor to be located at different places on the output anvil.

After the BDC sensor (27) has determined that the fastener has been driven, it provides a signal to the off timer delay circuit (36). The off timer delay circuit (36) resets the on timer delay circuit (33) causing the power source (3) to be disconnected from the motor (4). The motor (4) is then connected to a brake reducing its speed. The motor speed is reduced to less than 1000 rpm with the preferred speed being less than 10 rpm. The preferred brake is a simple dynamic brake accomplished by shunting the motor (4) through a low resistance circuit. Furthermore, the brake can also include reverse biasing the motor (4) from the power source (3). A further improvement can be gained for tools if a flywheel counter is combined with this braking effort. If the flywheel counter determines the number of flywheel turns that are required to brake the excess energy, this could be used in conjunction with a motor reversal mechanism to back up the kinetic energy storage device to allow for maximum input energy on the next nail drive cycle. This could be tailored to result in more uniform power input as well as allow an increase in overall driving power from cycle to cycle.

The off timer delay circuit (36) is set to a time of 10-500 milliseconds, with the preferred time period of 100 milliseconds. Once the off timer delay circuit (36) times out, the circuit operation can be re-initiated by pressing the activation switch (10).

Additional enhancements to this circuit include the addition of a cooling fan (37) and a top dead center (TDC) sensor (26) to detect that the anvil is in position for another cycle. The use of cooling fan (37), which is independently connected to power source (3), is advantageous for intermittent high power applications. This allows the motor (4) to be cooled for periods greater than the fraction of a second that it is running which prevents overheating and damage. The operation of the cooling fan (37) can be controlled by a timer in the logic circuit (32). Upon cycle initiation from the activation switch (10), the cooling fan (37) can be turned on coincident with the motor (4). The cooling fan (37) would remain on for a preset period of between 1 to 60 seconds with a preferred interval of 3 to 10 seconds.

Another enhancement is the use of the TDC sensor (26) to detect that the driving link or arm is in the rest position and ready for another cycle. The TDC sensor (26) feeds into the logic circuit (32). The logic circuit (32) determines that the TDC sensor (26) is reading correctly before allowing initiation of the next cycle. This helps prevent any kind of jamb in the device. The advantage of combining the TDC sensor and BDC sensor in addition to the flywheel rotation counter is evident in jamb conditions. In certain conditions, it is possible that the nail driving anvil may jamb during the drive of the nail into the substrate. One condition that could cause this is a poorly charged battery. By noting that the BDC had not been made during a cycle initiation, the flywheel counter could be used in conjunction with a motor reversal to allow the synchronous kinetic energy storing device to “back up” to allow for sufficient energy to drive the nail on the next cycle. If this were not done, it is possible that the jamb condition would be very difficult to clear as even after the jamb had been removed, there would be insufficient energy stored in the flywheel to allow it to drive the next nail. Additional improvements that are possible thru the use of a microprocessor controlled logic circuit (32) include redundant checking of the BDC sensor (27) and TDC sensor (26). Safety programming in the logic circuit (32) could include a lock out if the BDC sensor (27) activates more than one time per cycle of the activation switch (10). Additionally, the logic circuit (32) could verify operation of the sensors by checking for both off and on conditions. A final function of the logic circuit (32) is to ensure that the kinetic energy storage mechanism reaches its speed within a predetermined amount of time. Failure to do so could indicate that the power source (3) may need to be charged.

Further improvements in the circuit are useful for improving the safety of the fastener-driving tool (1). In order to prevent a short, from the power source (3) to the motor (4), from becoming a safety issue one or more of the following embodiments could be used. First, one of the legs which connects the power to the motor (4) from the power source device (3) could be connected via a second set of contacts on the trigger switch (10). This would not enable the nailer to fire unless both sets of contacts were made. A second embodiment would be to use a fusible link in one of the legs from the power source (3) to the motor (4). This fusible link could be a fuse, circuit reset device or an existing switching component such as an FET which would open on the application of a sustained high current pulse thus shutting the nailer device down and preventing multiple firings.

### INDUSTRIAL APPLICABILITY

The present invention is applicable in most residential and commercial construction settings. The nail gun can be utilized for general building construction, floor remodeling, palette construction, general manufactured housing, and roofing. The portability and size of the nail gun is ideal for more efficient construction and utilization in projects where the larger and more cumbersome nail guns are not ideal. Additionally, the power of the portable nail gun is a vast improvement of the current brad and staple systems on the market today.

We claim:

1. An apparatus for driving a fastener into a material comprising:
a power source;
a motor;
means for coupling said power source to said motor for the purpose of directing power from the power supply to the motor;
a kinetic energy storing mechanism;
means for coupling said motor to said kinetic energy storing mechanism to allow the motor to supply and transfer energy to said kinetic energy storing mechanism;
a clutching mechanism;
means for engaging said clutching mechanism with said kinetic energy storing mechanism;
a position sensitive fastener driving mechanism coupled to said clutching mechanism;
means for transferring energy from said kinetic energy storing mechanism to said position sensitive fastener driving mechanism;
a fastener; and
means for bringing the position sensitive fastener driving mechanism into contact with said fastener to drive said fastener into a substrate material.

2. The apparatus according to claim 1, wherein one or more sensors are used to detect the position of the position sensitive fastener driving mechanism.

3. The apparatus according to claim 1, wherein extra energy that remains in the position sensitive fastener driving mechanism, after the fastener is driven into the substrate material, is absorbed by elastomeric bumpers around the bottom dead center position of the position sensitive fastener driving mechanism.

4. The apparatus according to claim 1, wherein the position sensitive fastener driving mechanism engages the clutching mechanism in a range of +/−60 degrees around the top dead center position of the position sensitive fastener driving mechanism and disengages the clutching mechanism in a range of −10 to +90 degrees around the bottom dead center position of the position sensitive fastener driving mechanism.

5. (withdrawn):

6. (withdrawn):

7. (withdrawn):

8. The apparatus according to claim 1, wherein the means for coupling the motor to the kinetic energy storing mechanism has at least 2 degrees of rotational compliance during a cycle.

9. The apparatus according to claim 1, wherein the position sensitive fastener driving mechanism is further comprised of a crank link having a spring constant of less than 500 lbs per inch.

10. The apparatus according to claim 1, wherein the position sensitive fastener driving mechanism is returned to its starting position by a torsion spring.

11. (withdrawn):

12. The apparatus according to claim 1, wherein the motor is coupled to said kinetic energy storage mechanism through a reduction means of between 1.5:1 to 10:1.

13. The apparatus according to claim 1, wherein the clutching mechanism is a mechanical synchronous lockup clutch which positively engages and disengages the position sensitive fastener driving mechanism.

14. The apparatus according to claim 13, wherein the clutching mechanism is further comprised of a clutch pin whose position is determined by a barrel cam.

15. (withdrawn):

16. The apparatus according to claim 13, wherein the mechanical synchronous lockup clutch engages the position sensitive fastener driving mechanism between 10 to 500 revolutions of the motor.

17. (withdrawn):

18. An apparatus for driving a fastener into a material comprising:
a power source;
a motor;
means for coupling said power source to said motor for the purpose of directing power from the power source to the motor;
a kinetic energy storing mechanism;
means for coupling said motor to said kinetic energy storing mechanism to allow the motor to supply and transfer energy to said kinetic energy storing mechanism;
a clutching mechanism;
means for engaging said clutching mechanism with said kinetic energy storing mechanism;
a fastener driving mechanism further comprised by a crank link and an anvil wherein the fastener driving mechanism uses an intermediate link to couple said crank link to said anvil;
means for transferring energy from said kinetic energy storing mechanism to said fastener driving mechanism; a fastener; and
means for bringing the fastener driving mechanism into contact with said fastener to drive said fastener into a substrate material.

19. The apparatus according to claim 18, wherein one or more sensors are used to detect position of the fastener driving mechanism.

20. (withdrawn):

21. (withdrawn):

22. (withdrawn):

23. The apparatus according to claim 18, wherein the clutching mechanism is a mechanical synchronous lockup clutch which positively engages and disengages the position sensitive fastener driving mechanism.

24. The apparatus according to claim 23, further comprising a clutch pin wherein the position of said clutch pin is determined by a barrel cam.

25. The apparatus according to claim 23, wherein the mechanical synchronous lockup clutch engages the position sensitive fastener driving mechanism between 10 to 500 revolutions of the motor.

26. (withdrawn):

27. An apparatus for driving a fastener into a material comprising:
a power source;
a motor;
means for coupling said power source to said motor for the purpose of directing power from the power source to the motor;
a kinetic energy storing mechanism;
a compliant means for coupling said motor to said kinetic energy storing mechanism to allow the motor to supply and transfer energy to said kinetic energy storing mechanism;
a clutching mechanism;
means for engaging said clutching mechanism with said kinetic energy storing mechanism;
a fastener driving mechanism coupled to said clutching mechanism;
a compliant means for transferring energy from said kinetic energy storing mechanism to said position sensitive fastener driving mechanism;
a fastener; and
means for bringing the fastener driving mechanism into contact with said fastener to drive said fastener into a substrate material.

28. (withdrawn):

29. (withdrawn):

30. (withdrawn):

31. (withdrawn):

32. (withdrawn):

33. The apparatus according to claim 27, further comprising a drive shaft designed to have at least 2 degrees of complaint twist during an intermittent cycle.

34. The apparatus according to claim 27, further comprising a compliant coupling that allows at least 2 degrees of compliant twist during an intermittent cycle.

35. The apparatus according to claim 27, further comprising a link within the fastener driving mechanism having a cantilevered spring constant of less than 500 lbs/in.

36. The apparatus according to claim 27, further comprising a link within the fastener driving mechanism having an elastomeric insert to reduce shock load.

37. The apparatus according to claim 27, wherein the clutching mechanism is a mechanical synchronous lockup clutch which positively engages and disengages the fastener driving mechanism.

38. The apparatus according to claim 37, wherein the mechanical synchronous lockup clutch engages the fastener driving mechanism between 10 to 500 revolutions of the motor.

39. (withdrawn):

40. An apparatus for driving a fastener into a material comprising:
a power source;
a control circuitry device coupled to said power source;
a motor;
means for coupling said control circuitry device to said motor for the purpose of directing power from the power supply to the motor;
a kinetic energy storing mechanism;
means for coupling said motor to said kinetic energy storing mechanism to allow the motor to supply and transfer energy to said kinetic energy storing mechanism;
a clutching mechanism;
means for engaging said clutching mechanism with said kinetic energy storing mechanism;
a fastener driving mechanism couple to said clutching mechanism;
means for transferring energy from said kinetic energy storing mechanism to said fastener driving mechanism;
a fastener;
means for bringing the fastener driving mechanism into contact with said fastener to drive said fastener into a substrate material;
a braking mechanism coupled to the control circuitry device and the kinetic energy storing mechanism;
a means for engaging said braking mechanism to remove energy from the kinetic energy storing mechanism and from the motor; and
at least one sensor which determines the position of the fastener driving mechanism.

41. The apparatus according to claim 40, wherein the control circuitry device has the provision to reverse the direction of the kinetic energy storing mechanism.

42. The apparatus according to claim 40, wherein the fastener driving mechanism is a harmonic motion device.

43. The apparatus according to claim 40, wherein the fastener driving mechanism has a position sensitive link.

44. The apparatus according to claim 40, wherein the clutching mechanism is a mechanical synchronous lockup clutch which positively engages and disengages the fastener driving mechanism.

45. The apparatus according to claim 44, wherein the mechanical synchronous lockup clutch engages the fastener driving mechanism between 10 to 500 revolutions of the motor.

46. The apparatus according to claim 40, wherein the control circuitry device disconnects the power from the power source and initiates a lockout condition if the control circuitry device senses more than one pulse on the sensor for a single fastener drive cycle.

47. The apparatus according to claim 40, wherein the control circuitry device contains a cooling fan which is not connected to the motor shaft.

48. The apparatus according to claim 40, wherein the control circuitry device contains a fusible link.

49. The apparatus according to claim 40, wherein the braking mechanism uses dynamic braking from the motor to dissipate excess energy remaining in the kinetic energy storing mechanism after the fastener has been driven into the substrate material.

50. The apparatus according to claim 40, wherein the control circuitry device allows the motor to maintain a relatively constant speed after a selectable predetermined amount of energy is stored in the kinetic energy storing mechanism.

51. The apparatus according to claim 40, further comprising a counter which keeps track of the number of turns of the kinetic energy storing mechanism for each cycle.
